(19) United States
(12) Patent Application Publication
(10) Pub. No.: US 2008/0005378 A1
(43) Pub. Date: Jan. 3, 2008

(54) Chipset determinism for improved validation

(75) Inventors: James W. Alexander, Aloha, OR (US); Rajat Agarwal, Beaverton, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/437,592

(22) Filed: May 19, 2006

(51) Int. Cl. G06F 3/00

(52) U.S. Cl. 710/15

(57) ABSTRACT

Embodiments of the invention are generally directed to systems, methods, and apparatuses for chipset determinism to improve validation. In some embodiments, an integrated circuit synchronously receives one or more requests from a processor interconnect, exchanges the requests across an asynchronous interface, and releases a corresponding one or more responses to the processor interconnect on synchronous, deterministic time boundaries with respect to a specified deterministic event.

### TECHNICAL FIELD

Embodiments of the invention generally relate to the field of integrated circuits and, more particularly, to systems, methods and apparatuses for chipset determinism for improved validation.

### BACKGROUND

Debugging a processor (e.g., during post-silicon validation) frequently includes snooping the processor interconnect to capture the system state. The “processor interconnect” refers to the interconnect that connects the processor to, for example, the chipset. The captured system state is based, at least in part, on the responses that the processor receives from the chipset. For example, during the boot process, the processor sends a series of requests to the chipset (e.g., to obtain the boot vector, etc.). In response, the processor receives a series of responses that enable it to boot.

Conventional debugging techniques rely on the deterministic comparison of the captured system state to a simulated system state to identify the presence (or lack thereof) of bugs. The presence of “non-deterministic” behavior, however, can complicate the debugging of the processor. The term “non-deterministic” behavior refers to, for example, receiving a response from a device (or a collection of devices) that is different from the predicted response, but is still a valid response. Non-deterministic behavior can be introduced by the presence of asynchronous boundaries that are internal to a device. One example of an internal asynchronous boundary is the boundary between the receive logic clock domain of a high-speed input/output (I/O) port and the core logic domain.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating selected aspects of a computing system implemented according to an embodiment of the invention.

FIG. 2 is a timing diagram illustrating chipset determinism according to an embodiment of the invention.

FIG. 3 is a flow diagram illustrating selected aspects of a method for synchronously releasing responses to a processor interconnect, according to an embodiment of the invention.

FIG. 4 is a block diagram illustrating selected aspects of an electronic system according to an embodiment of the invention.

FIG. 5 is a bock diagram illustrating selected aspects of an electronic system according to an alternative embodiment of the invention.

### DETAILED DESCRIPTION

Embodiments of the invention are generally directed to systems, methods, and apparatuses for chipset determinism to improve validation (e.g., post-silicon validation). In some embodiments, an integrated circuit (e.g., part of computer system's chipset) receives an asynchronous request from a processor interconnect. The request is passed to an I/O subsystem through an asynchronous interface and a response is subsequently received from the I/O subsystem. As is further described below, in some embodiments, the response is released to the processor interconnect on deterministic time boundaries with respect to a specified deterministic event.

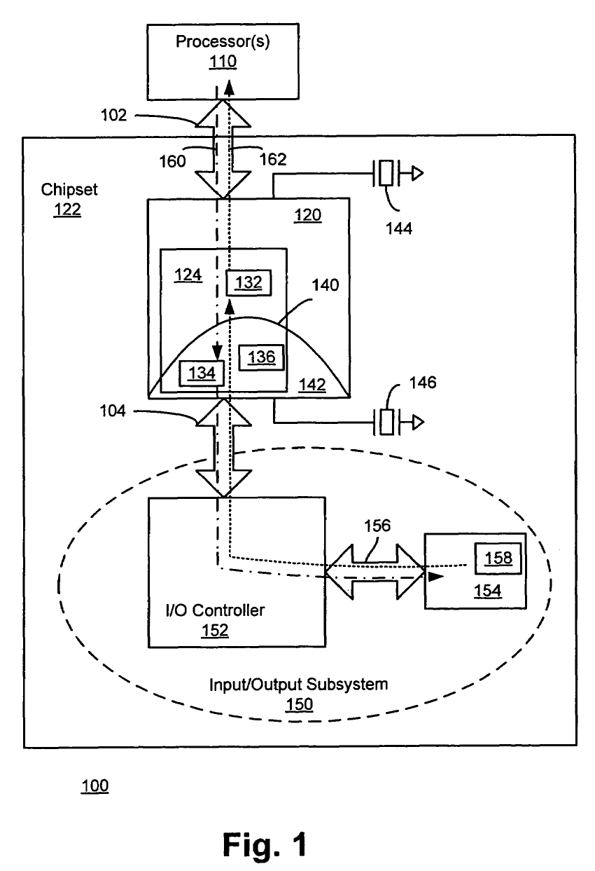

FIG. 1 is a block diagram illustrating selected aspects of a computing system implemented according to an embodiment of the invention. In some embodiments, system 100 includes processor(s) 110, integrated circuit 120, and input/output (I/O) subsystem 150. In alternative embodiments, system 100 may include more elements, fewer elements, and/or different elements.

Processor(s) 110 may be any type of processing device. For example, processor 110 may be a microprocessor, a microcontroller, or the like. Further, processor 110 may include any number of processing cores or may include any number of separate processors.

Processor 110 is coupled with integrated circuit 120 via processor interconnect 102. Processor interconnect 102 may be any type of processor interconnect including a parallel bus and/or a high-speed serial interconnect. In some embodiments, processor interconnect 102 is a cache coherent interconnect.

Integrated circuit 120 is an element of chipset 122. In some embodiments, integrated circuit (IC) 120 is part of an IC that has a number of functions such as a coherency engine, a memory controller, a memory controller hub (e.g., a northbridge), and the like. In alternative embodiments, integrated circuit 120 may be integrated with a different component of a chipset.

Integrated circuit 120 is coupled with I/O subsystem 120 via interconnect 104. In some embodiments, interconnect 104 is a high speed point-to-point interconnect. For example, in some embodiments, interconnect 104 is based, at least in part, on direct media interface (DMI) technology. In alternative embodiments, interconnect 104 may be based on a different technology.

Input/output (I/O) subsystem 150 includes I/O controller 152 and non-volatile memory device 154. I/O controller 152 includes circuitry to perform tasks (and monitor operations) related to receiving input and transferring output for computing system 100. Non-volatile memory device 154 may be any type of non-volatile memory device including, for example, a flash memory device. In some embodiments, non-volatile memory device 154 stores the read only memory (ROM) code used to boot system 100 (e.g., the boot-up data).

In some embodiments, integrated circuit 120, interconnect 104, and/or I/O subsystem 150 may introduce non-deterministic behavior to chipset 122. The non-deterministic behavior is, in part, due to the presence of asynchronous clock domains within (and/or between) integrated circuit 120 and/or I/O subsystem 150. In the illustrated example, interconnect 104 operates at a first clock speed determined, at least in part, by clock 146 and the core circuitry of integrated circuit 120 operates at a second clock speed determined, at least in part, by clock 144. The difference in clock speeds creates asynchronous boundary 140.

Integrated circuit 120 includes determinism logic 124 to provide aspects of determinism for chipset 122. Determinism logic 124 includes response queue 132, request queue 134, and timer 136. In alternative embodiments, determinism logic 124 includes more elements, fewer elements, and/or different elements.

In operation, integrated circuit 120 receives a request from processor interconnect 102 as shown by 160. The request may be, for example, a request for boot-up data 158 (e.g., a request for the boot vector). In some embodiments, a first request may be allowed to pass through to I/O subsystem 150. Subsequent requests may be queued in request queue 134 until a response corresponding to a previously passed request is received from I/O subsystem 150.

I/O subsystem 154 processes the request and provides a response (as shown by 162). For example, if the request is for an element of boot-up data 158, then I/O subsystem 150 may provide the requested element. In some embodiments, determinism logic 124 controls the response so that it is synchronously returned to processor interconnect 102. As is further described below, in some embodiments, determinism logic 124 releases at least some of the responses to processor interconnect 102 on deterministic time boundaries with respect to a specified deterministic event.

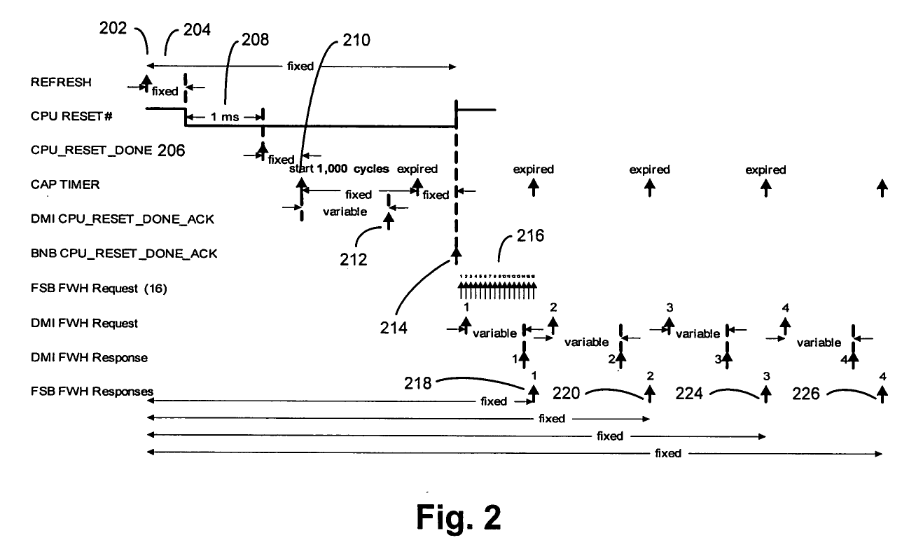

FIG. 2 is a timing diagram illustrating selected aspects of the operation of determinism logic (e.g., determinism logic 124, shown in FIG. 1), according to an embodiment of the invention. As illustrated by FIG. 2, in some embodiments, the determinism logic operates to make the request/response sequence deterministic (e.g., predictable). It is to be appreciated that the operation of the determinism logic shown in FIG. 2 is for illustrative purposes. In alternative embodiments, the operation of the determinism logic may be different.

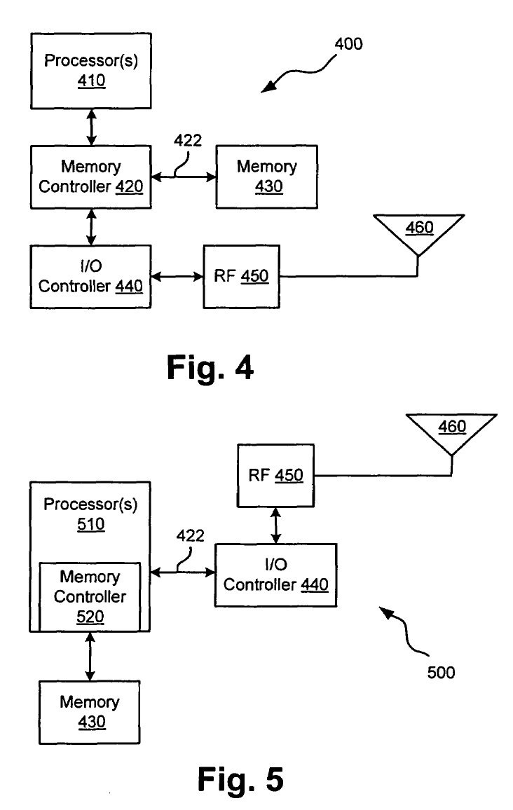

In some embodiments, the start of a processor reset is linked to the beginning of a refresh sequence for all of memory (e.g., a refresh of main system memory such as memory 430, shown in FIG. 4). Referring to 202, for example, the processor reset occurs on the beginning of a refresh sequence for all of memory. There is a fixed length of time between the refresh signal and asserting the reset as shown by 204. The fixed length of time is determined by register-transfer-level (RTL) trickle time. For a given implementation of, for example, integrated circuit 120, the fixed length of time is the same.

In some embodiments, CPU_RESET_DONE 206 is provided at a fixed interval of time after the reset is asserted (e.g., 1 ms) as shown by 208. A cap timer (e.g., timer 136, shown in FIG. 1) is started after the conclusion of the fixed interval (210). The cap timer produces a periodic heartbeat which may be used to bound events that would otherwise be non-deterministic. In some embodiments, the purpose of the first heartbeat is to bound the first asynchronous event, namely, receiving the DMI CPU_RESET_DONE_ACK as shown by 212.

The reset done ack is sent to the processor interconnect at the expiration of the timer (plus a fixed length of RTL trickle time) as shown by 214 and the reset is de-asserted. In some embodiments, after the reset is de-asserted the integrated circuit receives one or more requests from the processor interconnect (216). The requests may be, for example, requests from a processor for boot-up data (e.g., boot-up data 158). The requests may be queued in a request queue (e.g., request queue 134, shown in FIG. 1). In some embodiments, the first request is passed to the I/O subsystem. Subsequent requests are sent to the I/O subsystem after responses to the prior request are received from the I/O subsystem.

In some embodiments, the integrated circuit back pressures the processor sending the requests to limit the number of requests stored in the request queue. The term “back pressures” refers to asserting a priority (or other signal) that indicates that the integrated circuit is not accepting additional requests from the processor interconnect. For example, in some embodiments, the integrated circuit may back pressure the processor if the request queue is (or the request queues are) full.

In some embodiments, the periodic expiration of the cap timer is used to bound the release of the responses to the processor interconnect. For example, the first response is released to the processor interconnect at the expiration of the timer as shown by 218. Similarly, the second response is released to the processor interconnect at the next expiration of the timer as shown by 220. The process of bounding the release of the responses to the processor interconnect may be repeated for each response (e.g., as shown, at least in part, by 224-226).

The period of the cap timer may be defined to be long enough that there can be reasonable certainty that a response will be in the response queue and ready to be released to the processor interconnect at the expiration of the period. In some embodiments, the period of the cap timer is greater than or equal to a round-trip time between the integrated circuit and the I/O subsystem. In alternative embodiments, the expiration period of the cap timer may be different.

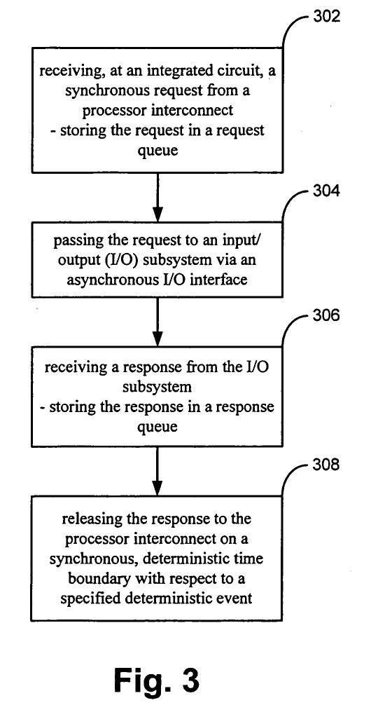

FIG. 3 is a flow diagram illustrating selected aspects of a method for synchronously releasing responses to a processor interconnect, according to an embodiment of the invention. Referring to process block 302, an integrated circuit (e.g., integrated circuit 120, shown in FIG. 1) receives an asynchronous request from a processor interconnect. The term “asynchronous” request refers to a request that is received asynchronously with respect to other requests. The request may be stored in a request queue (e.g. request queue 134, shown in FIG. 1).

Referring to process block 304, the request is passed to an I/O subsystem via an asynchronous interface. An “asynchronous interface” refers to an interface that is operating at a different frequency than the core logic of the integrated circuit. An example of an asynchronous interface is interconnect 104, shown in FIG. 1.

In some embodiments, the integrated circuit may receive a series of requests. The first request of the series may be passed to an I/O subsystem without being stored in the request queue. The subsequent requests may be stored in the request queue and passed to the I/O subsystem after responses to the prior requests are received.

Referring to process block 306, the integrated circuit receives a response (corresponding to the request) from the I/O subsystem. The response may be stored in a response queue (e.g., response queue 132, shown in FIG. 1). Referring to process block 308, the response is released to the processor interconnect on a deterministic time boundary with respect to a specific deterministic event. The deterministic time boundary may be defined, for example, by the periodic expiration of a cap timer (e.g., timer 136, shown in FIG. 1). In some embodiments, the specific deterministic event is the beginning of a sequence of refreshes for all of memory. Subsequent responses may also be stored in the response queue and released on a deterministic time boundary with respect to a specific deterministic event.

FIG. 4 is a block diagram illustrating selected aspects of an electronic system according to an embodiment of the invention. Electronic system 400 includes processor 410, memory controller 420, memory 430, input/output (I/O) controller 440, radio frequency (RF) circuits 450, and antenna 460. In operation, system 400 sends and receives signals using antenna 460, and these signals are processed by the various elements shown in FIG. 4. Antenna 460 may be a directional antenna or an omni-directional antenna. As used herein, the term omni-directional antenna refers to any antenna having a substantially uniform pattern in at least one plane. For example, in some embodiments, antenna 460 may be an omni-directional antenna such as a dipole antenna or a quarter wave antenna. Also, for example, in some embodiments, antenna 460 may be a directional antenna such as a parabolic dish antenna, a patch antenna, or a Yagi antenna. In some embodiments, antenna 460 may include multiple physical antennas.

Radio frequency circuit 450 communicates with antenna 460 and I/O controller 440. In some embodiments, RF circuit 450 includes a physical interface (PHY) corresponding to a communication protocol. For example, RF circuit 450 may include modulators, demodulators, mixers, frequency synthesizers, low noise amplifiers, power amplifiers, and the like. In some embodiments, RF circuit 450 may include a heterodyne receiver, and in other embodiments, RF circuit 450 may include a direct conversion receiver. For example, in embodiments with multiple antennas 460, each antenna may be coupled to a corresponding receiver. In operation, RF circuit 450 receives communications signals from antenna 460 and provides analog or digital signals to I/O controller 440. Further, I/O controller 440 may provide signals to RF circuit 450, which operates on the signals and then transmits them to antenna 460.

Processor(s) 410 may be any type of processing device. For example, processor 410 may be a microprocessor, a microcontroller, or the like. Further, processor 410 may include any number of processing cores or may include any number of separate processors.

Memory controller 420 provides a communication path between processor 410 and other elements shown in FIG. 4. In some embodiments, memory controller 420 is part of a hub device that provides other functions as well. In some embodiments, this hub device includes logic to provide chipset determinism for validation. As shown in FIG. 4, memory controller 420 is coupled to processor(s) 410, I/O controller 440, and memory 430.

Memory 430 may include multiple memory devices. These memory devices may be based on any type of memory technology. For example, memory 430 may be random access memory (RAM), dynamic random access memory (DRAM), static random access memory (SRAM), nonvolatile memory such as FLASH memory, or any other type of memory.

Memory 430 may represent a single memory device or a number of memory devices on one or more modules. Memory controller 420 provides data through interconnect 422 to memory 430 and receives data from memory 430 in response to read requests. Commands and/or addresses may be provided to memory 430 through interconnect 422 or through a different interconnect (not shown). Memory controller 430 may receive data to be stored in memory 430 from processor 410 or from another source. Memory controller 430 may provide the data it receives from memory 430 to processor 410 or to another destination. Interconnect 422 may be a bi-directional interconnect or a unidirectional interconnect. Interconnect 422 may include a number of parallel conductors. The signals may be differential or single ended. In some embodiments, interconnect 422 operates using a forwarded, multiphase clock scheme.

Memory controller 420 is also coupled to I/O controller 440 and provides a communications path between processor(s) 410 and I/O controller 440. I/O controller 440 includes circuitry for communicating with I/O circuits such as serial ports, parallel ports, universal serial bus (USB) ports and the like. As shown in FIG. 4, I/O controller 440 provides a communication path to RF circuits 450.

FIG. 5 is a bock diagram illustrating selected aspects of an electronic system according to an alternative embodiment of the invention. Electronic system 500 includes memory 430, I/O controller 440, RF circuits 450, and antenna 460, all of which are described above with reference to FIG. 4. Electronic system 500 also includes processor(s) 510 and memory controller 520. As shown in FIG. 5, memory controller 520 may be on the same die as processor(s) 510. In some embodiments, this memory controller 520 includes logic to provide chipset determinism for validation. Processor(s) 510 may be any type of processor as described above with reference to processor 410. Example systems represented by FIGS. 4 and 5 include desktop computers, laptop computers, servers, cellular phones, personal digital assistants, digital home systems, and the like.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. An integrated circuit comprising:
an input/output port to asynchronously receive one or more requests from a processor interconnect;
an asynchronous I/O interface to pass the one or more requests to an I/O subsystem and to receive a corresponding one or more responses from the I/O subsystem; and
determinism logic to release each of the one or more responses to the processor interconnect on deterministic time boundaries with respect to a specified deterministic event.

2. The integrated circuit of claim 1, wherein the determinism logic comprises a timer to define the deterministic time boundaries by providing a periodic heartbeat having a fixed interval.

3. The integrated circuit of claim 2, wherein the determinism logic further comprises a response queue to store the responses until they are released to the processor interconnect based, at least in part, on the periodic heartbeat of the timer.

4. The integrated circuit of claim 2, wherein the determinism logic further comprises a request queue to store at least some of the one or more requests, wherein each successive request is to be passed to the I/O subsystem subsequent to receiving a response corresponding to a previous request.

5. The integrated circuit of claim 1, wherein the deterministic event is the beginning of a sequence of refreshes for all of memory.

6. The integrated circuit of claim 1, wherein the integrated circuit comprises a coherency engine.

7. The integrated circuit of claim 6, wherein the processor interconnect is a cache coherent interconnect.

8. A method comprising:
receiving, at an integrated circuit, an asynchronous request from a processor interconnect;
passing the asynchronous request to an input/output (I/O) subsystem via an asynchronous I/O interface;
receiving a response from the I/O subsystem; and
releasing the response to the processor interconnect on a deterministic time boundary with respect to a specified deterministic event.

9. The method of claim 8, further comprising:
repeating the method for one or more requests subsequently received from the processor interconnect.

10. The method of claim 8, wherein the deterministic time boundary is defined, at least in part, by a timer, wherein the timer is to provide a periodic heartbeat having a fixed interval.

11. The method of claim 10, wherein the fixed interval is greater than or equal to a round-trip time from the integrated circuit to the I/O subsystem.

12. The method of claim of claim 8, further comprises:
storing the response in a response queue prior to releasing the response to the processor interconnect.

13. The method of claim 8, wherein the integrated circuit comprises a memory controller hub.

14. The method of claim 8, wherein the specified deterministic event is the beginning of a sequence of refreshes for all of memory.

15. A system comprising:
an integrated circuit including
an input/output (I/O) port to asynchronously receive one or more requests from a processor interconnect,
an asynchronous I/O interface to pass the one or more requests to an I/O subsystem and to receive a corresponding one or more responses from the I/O subsystem, and
determinism logic to release each of the responses to the processor interconnect on deterministic time boundaries with respect to a specified deterministic event; and
an I/O subsystem coupled with the integrated circuit through an asynchronous I/O interface, wherein the I/O subsystem includes a non-volatile memory coupled with the I/O subsystem to provide boot-up data.

16. The system of claim 15, wherein the determinism logic comprises a timer to define the deterministic time boundaries by providing a periodic heartbeat having a fixed interval.

17. The system of claim 16, wherein the determinism logic further comprises a response queue to store the responses until they are released to the processor interconnect based, at least in part, on the periodic heartbeat of the timer.

18. The system of claim 16, wherein the determinism logic further comprises a request queue to store at least some of the one or more requests, wherein each successive request is to be passed to the I/O subsystem subsequent to receiving a response corresponding to a previous request.

19. The system of claim 15, wherein the specified deterministic event is the beginning of a sequence of refreshes for all of memory.

20. The system of claim 15, wherein the integrated circuit comprises a coherency engine.

21. The system of claim 20, wherein the processor interconnect is a cache coherent interconnect.
